(19) United States
(12) Patent Application Publication
(10) Pub. No.: US 2004/0190298 A1
(43) Pub. Date: Sep. 30, 2004

(54) Portable light device

(75) Inventors: Saharut Sirichai, Culver City, CA (US); Ernesto Quinteros, Los Angeles, CA (US); Vijendra Nalwad, Newbury Park, CA (US); Vincent Razo, Granada Hills, CA (US)

Correspondence Address: Kenneth A. Nelson, Bryan Cave LLP, Suite 2200, Two North Central Avenue, Phoenix, AZ, 85004-4406, US

(73) Assignee: Belkin Corporation

(21) Appl. No.: 10/397,896

(22) Filed: Mar. 25, 2003

(51) Int. Cl. F21V 21/00

(52) U.S. Cl. 362/387; 362/396; 362/427; 362/85

(57) ABSTRACT

A portable light device includes an electrical connector (110), an electrical cord (120) coupled to the electrical connector, a retraction mechanism (130) coupled to the electrical cord, and a light source (140) coupled to the electrical cord. The electrical cord electrically couples the light source to the electrical connector, and the retraction mechanism is capable of retracting the electrical cord.

This is a continuation-in-part of Application Ser. No. ______, having attorney docket number 134454-02, filed Mar. 3, 2003.

### FIELD OF THE INVENTION

This invention relates generally to light devices, and relates more particularly to portable light devices capable of use with electronic devices.

### BACKGROUND OF THE INVENTION

The increased portability of electronic devices, including laptop computers, has lead to the widespread use of such electronic devices in places where adequate lighting may not be available. For example, a traveler using a laptop computer on an airplane may have difficulty seeing the computer's keyboard when the airplane cabin lights are turned down. Even where reading lights are provided inside the airplane cabin, their intensity and orientation may be such that the reading lights either disturb other passengers or do not adequately illuminate the computer keyboard or other objects of interest.

Existing solutions to the inadequate lighting problem include light devices in which a connector capable of connecting to a computer's power supply is coupled to a light source by a length of flexible tubing. The flexible tubing may be positioned and repositioned as needed so as to direct illumination from the light source to a desired location. These existing light devices are flawed, however, in that the flexible tubing can be difficult to manage and tends to weaken and break over time. Furthermore, the light devices are bulky and difficult to store. Accordingly, there is a need for a compact, easily-manageable, and portable light device capable of use with portable electronic devices such as laptop computers.

### BRIEF DESCRIPTION OF THE DRAWINGS

The invention will be better understood from a reading of the following detailed description, taken in conjunction with the accompanying figures in the drawings in which:

FIG. 1 is a left side isometric view of a portable light device according to an embodiment of the invention shown in a first position;

FIG. 2 is a right side isometric view of the portable light device of FIG. 1 shown in a second position;

FIG. 3 is an exploded view of the portable light device; and

FIG. 4 is an isometric view of a portion of the portable light device of FIG. 1 according to an embodiment of the invention.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Furthermore, the terms “comprise,” “include,” “have,” and any variations thereof, are intended to cover a non-exclusive inclusion, such that a process, method, article, or apparatus that comprises a list of elements is not necessarily limited to those elements, but may include other elements not expressly listed or inherent to such process, method, article, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical, mechanical, or other manner.

### DETAILED DESCRIPTION OF THE DRAWINGS

In one embodiment of the invention, a portable light device comprises an electrical connector, an electrical cord coupled to the electrical connector, a retraction mechanism coupled to the electrical cord, and a light source coupled to the electrical cord. The electrical cord electrically couples the light source to the electrical connector, and the retraction mechanism is capable of retracting the electrical cord.

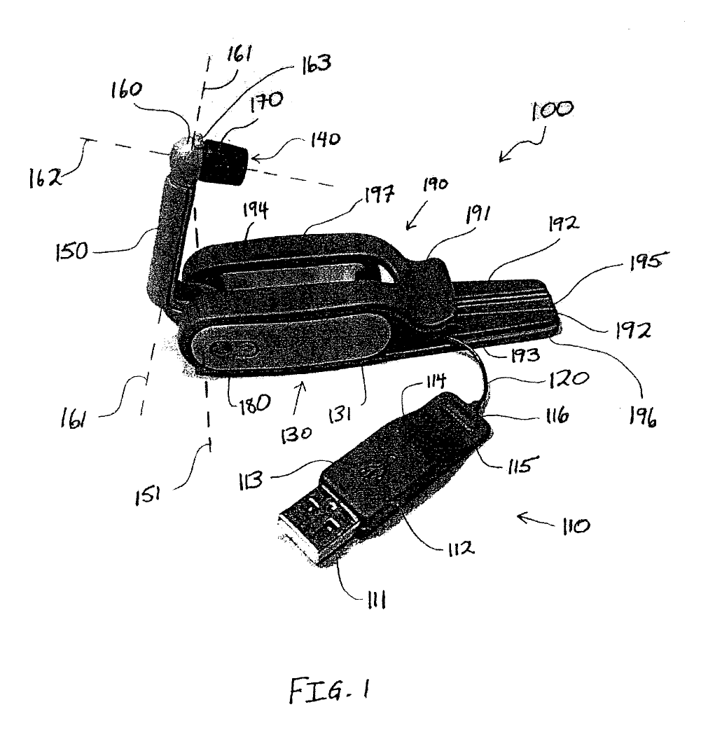

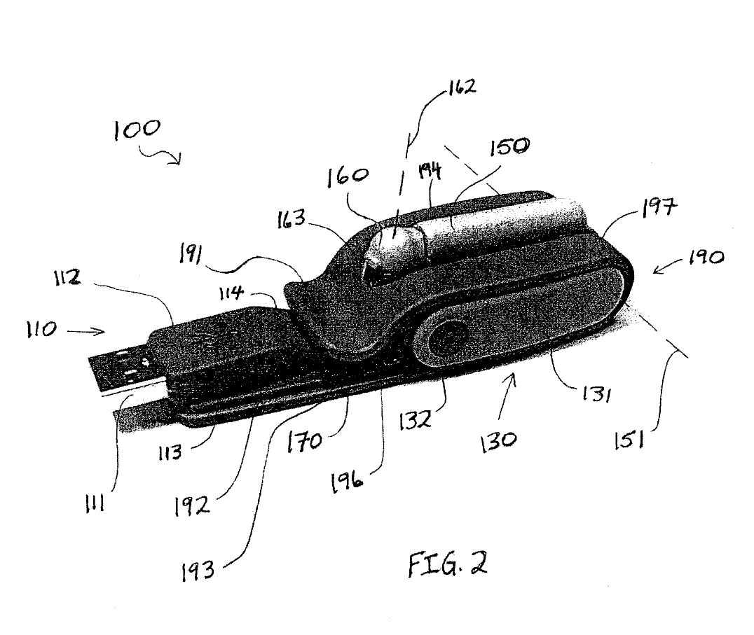

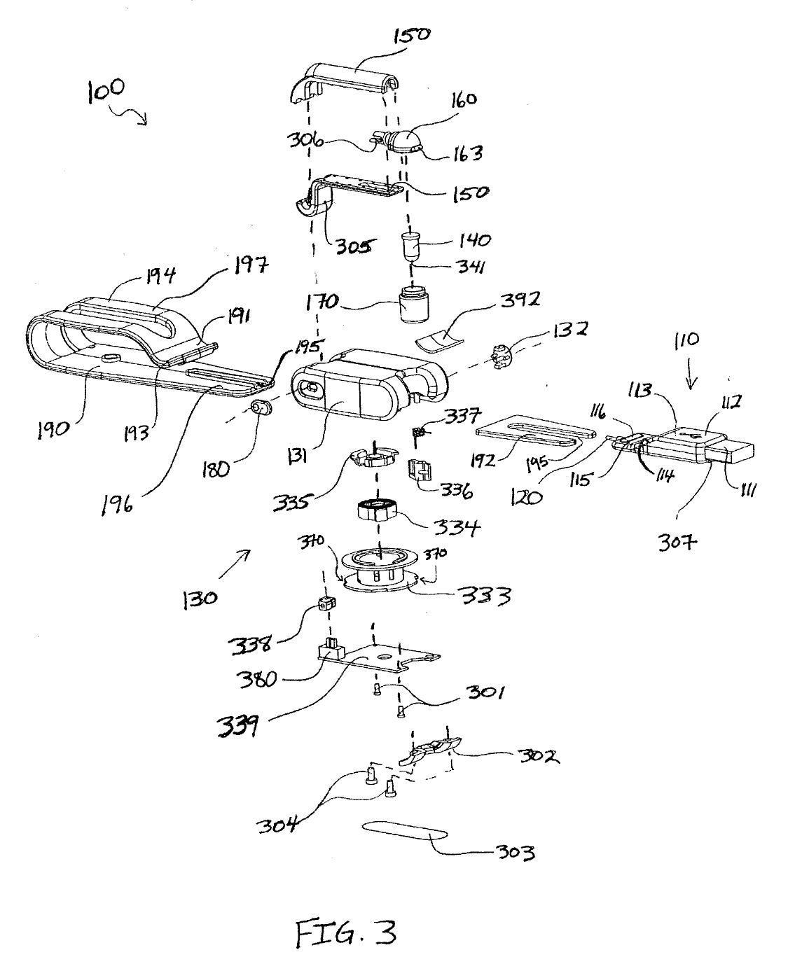

FIGS. 1 and 2 illustrate left and right side isometric views, respectively, of a portable light device 100 in two different positions and according to an embodiment of the invention. FIG. 3 is an exploded view of portable light device 100 according to an embodiment of the invention. Referring to FIGS. 1, 2, and 3, portable light device 100 comprises an electrical connector 110, an electrical cord 120 coupled to electrical connector 110, a retraction mechanism 130 coupled to electrical cord 120, and a light source 140 coupled to electrical cord 120. Electrical cord 120 electrically couples light source 140 to electrical connector 110. Electrical connector 110 is capable of connecting to and drawing power from an electronic device with or for which portable light device 100 is used. Accordingly, portable light device 100 needs no additional power source. Particular embodiments of electrical connector 110 will be discussed below. In a different embodiment, portable light device 100 can be powered by the electronic device, but used for an application other than illuminating the electronic device.

Retraction mechanism 130 is capable of retracting electrical cord 120. In one embodiment, retraction mechanism 130 is a mechanical and non-electrical mechanism comprising a housing 131, an actuator 132 extending through a portion of housing 131, and a spring 334 (FIG. 3) and a spool 333 (FIG. 3) inside housing 131. As an example, actuator 132 can be a button or a lever. Electrical cord 120 winds around spool 333 in response to a manipulation of actuator 132. In one embodiment, spool 333 may comprise a material having a low coefficient of friction such that electrical cord 120 smoothly and efficiently winds around and unwinds from spool 333. As an example, spool 333 may comprise polyoxymethylene. Electrical cord 120 may be withdrawn from housing 131, by pulling on electrical connector 110, for example. In a particular embodiment, electrical cord 120 may have a length of between approximately 45 and 60 centimeters.

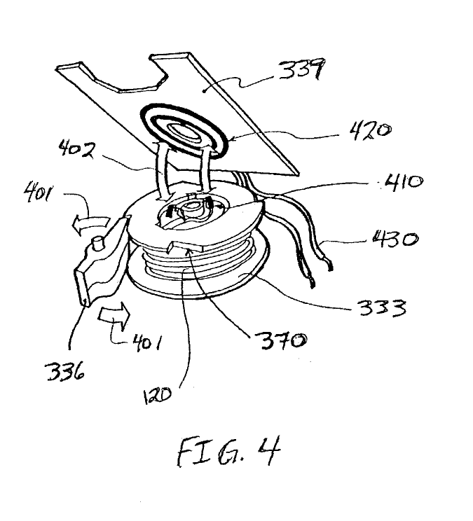

FIG. 4 is an isometric view of a portion of the portable light device of FIG. 1 according to an embodiment of the invention. Referring to FIG. 4, and still to FIG. 3, retraction mechanism 130 may further comprise a lid 335, a latch 336, a spring 337, and a floor 339. Spool 333 includes a ratchet 370. In one embodiment, lid 335 secures spring 334 in spool 333. In the same or another embodiment, spring 337 responds to a manipulation of actuator 132 by releasing latch 336 as indicated by arrows 401 (FIG. 4), which in turn releases ratchet 370 on spool 333, thereby permitting spring 334 to uncoil and to rotate spool 333 to retract electrical cord 120 into housing 131 and around spool 333. Only a portion of electrical cord 120 is shown in FIG. 3.

Spool 333 further comprises contacts 410 (FIG. 4). Floor 339 further comprises contacts 420 which are electrically coupled to contacts 410, as indicated by arrows 402. Wires 430 carry power from contacts 420 to light source 140. Fasteners 301 may hold floor 339 in place at the bottom of housing 131. Fasteners 304 may secure housing 131 to clip 190. As an example, fasteners 301 and fasteners 304 can be screws or pins. A label 303 may be located on an underside of a lower piece 196 of a clip 190. In one embodiment, a cap 302 may be inserted into housing 131.

Referring again to FIGS. 1, 2, and 3, portable light device 100 further comprises an articulating arm 150 and a connector 160 coupling articulating arm 150 to light source 140. In a particular embodiment, articulating arm 150 is rigid, not flexible. Articulating arm 150 is rotatable about an axis 151 (FIGS. 1 and 2) and is capable of movement between a closed position, such as is shown in FIG. 2, and a variety of open positions, one of which is shown in FIG. 1. In one embodiment, articulating arm 150 comprises a detent 305 (FIG. 3) resistive to movement of articulating arm 150 out of the closed position illustrated in FIG. 2. When articulating arm 150 is in the closed position, articulating arm 150 may be described as being at an angle of zero degrees with respect to retraction mechanism 130. In one embodiment, the open positions into which articulating arm 150 may be moved include all positions in which the angle between articulating arm 150 and retraction mechanism 130 is greater than zero degrees. In a particular embodiment, articulating arm 150 may be extended to a maximum angle of at least 180 degrees. When in an open position, articulating arm 150 may be held in place by friction between articulating arm 150 and housing 131.

At least a portion of light source 140 can be located inside connector 160. Connector 160 supports light source 140 and is rotatable about an axis 161 (FIG. 1), which can be different from axis 151. In one embodiment, axis 161 may be perpendicular to axis 151. Connector 160 is capable of movement into and out of a central position in which connector 160 and light source 140 are aligned with an axis 162, which can be perpendicular to axes 151 and 161. When portable light device 100 is in the closed position (FIG. 2), connector 160 is in the central position. In one embodiment, connector 160 comprises a detent 306 resistive to movement of connector 160 out of the central position. In the same or another embodiment, connector 160 may further comprise a ridge 163. Ridge 163 acts as a handle, enabling a user of portable light device 100 to more easily lift articulating arm 150 out of the closed position than would be possible if connector 160 lacked ridge 163 and instead had a surface that was completely smooth.

Portable light device 100 may still further comprise a light baffle 170 coupled to connector 160. In one embodiment, light source 140 comprises a first end 341 (FIG. 3), distal to articulating arm 150, and light baffle 170 circumscribes and protrudes beyond first end 341 of light source 140.

In one embodiment, portable light device 100 can further comprise an on/off switch 180 coupled to light source 140. As an example, on/off switch 180 may comprise a push-button switch, a sliding switch, or another type of on/off switch as known in the art. In a particular embodiment, on/off switch 180 may comprise, or may cooperate with, a potentiometer, not shown, capable of varying the intensity of light provided by light source 140. In the same or another embodiment, on/off switch 180 can be coupled to an actuation-slider 338 (FIG. 3), which activates a slide switch 380 (FIG. 3) on floor 339.

Portable light device 100 can further comprise clip 190 coupled to retraction mechanism 130. As illustrated in FIG. 2, electrical connector 110 can be directly or indirectly secured by clip 190 when electrical cord 120 is retracted within retraction mechanism 130. Clip 190 comprises lower piece 196 and an upper piece 197. In operation, upper piece 197 may be pulled away from lower piece 196 to a sufficient distance to allow clip 190 to be slipped over, for example, a laptop computer screen. Upper piece 197 could then be adjacent to and rest against the front of the laptop computer screen, and lower piece 196 could be adjacent to and rest against the back of the laptop computer screen. Portable light device 100 can be placed, for example, at any location along the top or along the sides of the laptop computer screen. In one embodiment, the back surface of lower piece 196 is smooth and flat, thus making portable light device 100 suitable for placement and operation on a tabletop or other horizontal or substantially horizontal surface in addition to the placement already discussed, i.e., clipped to a laptop computer screen.

In one embodiment, clip 190 comprises a polycarbonate material. In a particular embodiment, clip 190 further comprises pad 192, which can have a U-shape. A channel 195 (FIGS. 1 and 3) in lower piece 196 of clip 190 can be located between the parallel legs of pad 192. A pad 392 (FIG. 3) may be located underneath a portion 191 of upper piece 197. Pads 192 and pad 392 may provide friction between clip 190 and an electronic device such as a laptop computer, not shown, to which portable light device 100 may be attached. As an example, pads 192 and pad 392 may be made of rubber. Upper piece 197 can also comprise a lip 193 to facilitate the attachment of clip 190 to another device.

Upper piece 197 can further comprise a U-shaped portion 194 in which articulating arm 150, connector 160, light baffle 170, and light source 140 are located when portable light device 100 is in the closed position. As an example, portion 191 can couple together U-shaped portion 194 and lip 193.

Clip 190 and electrical connector 110, in certain embodiments, function together to add to the stability and compactness of portable light device 100. In one embodiment, electrical connector 110 comprises a USB plug 111 and an overmold 112. An electrical connector comprising a USB plug will be referred to herein as a USB connector. USB plug 111 is capable of drawing power to operate light source 140 from a USB port of a laptop computer or other portable or non-portable electronic device. In a different embodiment, USB plug 111 can be replaced with a different connector that is capable of supplying power to light source 140.

Overmold 112 comprises a portion 113, a portion 114, and a portion 115. Portion 115 may include a ridge 116. Portion 115 of overmold 112 may have a thickness suitable to fit between portion 191 and lower piece 196 of clip 190, while portion 114 of overmold 112 may have a slope similar to a slope of lip 193 of clip 190. When electrical cord 120 is substantially, fully retracted into housing 131, electrical connector 110 is held in place due in part to pressure applied by lip 193 to portion 114 of overmold 112 and by portion 191 of clip 190 and pad 392 to portion 115 of overmold 112, as shown in FIG. 2. Ridge 116 may resist movement of electrical cord 120 away from the fully retracted position, by bumping against portion 191 and/or pad 392, thus also helping to retain electrical cord 120 in the substantially, fully retracted position. Overmold 112 may further comprise a guide track 307 (FIG. 3), located on an underside of overmold 112 and adapted to fit within channel 195 (FIGS. 1 and 3). Guide track 307 may comprise an elongated ridge protruding from the underside of portions 113, 114, and/or 115 of overmold 112.

Although the invention has been described with reference to specific embodiments, it will be understood by those skilled in the art that various changes may be made without departing from the spirit or scope of the invention. Various examples of such changes have been given in the foregoing description. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that the portable light device discussed herein may be implemented in a variety of embodiments, and that the foregoing discussion of certain of these embodiments does not necessarily represent a complete description of all possible embodiments.

All elements claimed in the claims are essential to the invention, and replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A portable light device comprising:
an electrical connector;
an electrical cord coupled to the electrical connector;
a retraction mechanism coupled to the electrical cord; and
a light source coupled to the electrical cord,
wherein:
the electrical cord electrically couples the light source to the electrical connector; and
the retraction mechanism is capable of retracting the electrical cord.

2. The portable light device of claim 1 wherein:
the electrical connector comprises a USB plug.

3. The portable light device of claim 1 wherein:
the retraction mechanism comprises:
a housing;
an actuator extending through a portion of the housing;
a spring inside the housing; and
a spool inside the housing.

4. The portable light device of claim 1 further comprising:
an articulating arm coupled to the light source.

5. The portable light device of claim 4 wherein:
the articulating arm is rotatable about a first axis.

6. The portable light device of claim 5 further comprising:
a connector coupled to the articulating arm,
wherein:
the light source is supported by the connector; and
the connector is rotatable about a second axis different from the first axis.

7. The portable light device of claim 4 further comprising:
a light baffle circumscribing the light source.

8. The portable light device of claim 7 wherein:
the light source comprises a first end distal to the articulating arm; and
the light baffle protrudes beyond the first end of the light source.

9. The portable light device of claim 7 further comprising:
an on/off switch coupled to the light source.

10. The portable light device of claim 4 further comprising:
a clip coupled to the retraction mechanism.

11. The portable light device of claim 10 wherein:
the electrical connector is secured by the clip when the electrical cord is retracted.

12. The portable light device of claim 10 further comprising:
an on/off switch coupled to the light source.

13. The portable light device of claim 4 further comprising:
an on/off switch coupled to the light source.

14. The portable light device of claim 1 further comprising:
a light baffle circumscribing the light source.

15. The portable light device of claim 14 further comprising:
a clip coupled to the retraction mechanism.

16. The portable light device of claim 15 wherein:
the electrical connector is secured by the clip when the electrical cord is retracted.

17. The portable light device of claim 15 further comprising:
an on/off switch coupled to the light source.

18. The portable light device of claim 14 further comprising:
an on/off switch coupled to the light source.

19. The portable light device of claim 1 further comprising:
a clip coupled to the retraction mechanism.

20. The portable light device of claim 19 wherein:
the electrical connector is secured by the clip when the electrical cord is retracted.

21. The portable light device of claim 19 further comprising:
an on/off switch coupled to the light source.

22. A portable light device comprising:
a USB connector;
an electrical cord coupled to the USB connector;
a retraction mechanism coupled to the electrical cord;
a light source coupled to the electrical cord;
an articulating arm coupled to the light source;
a light baffle circumscribing the light source; and
a clip coupled to the retraction mechanism,
wherein:
the articulating arm is rigid;
the electrical cord electrically couples the light source to the USB connector;
the retraction mechanism is capable of retracting the electrical cord within the retraction mechanism; and
the USB connector is secured by the clip when the electrical cord is retracted within the retraction mechanism.

23. The portable light device of claim 22 wherein:
the retraction mechanism comprises:
a housing;
an actuator extending through a portion of the housing;
a spring inside the housing; and
a spool inside the housing; and
a manipulation of the actuator permits the spring to uncoil to rotate the spool to wind the electrical cord around the spool and to retract the electrical cord into the housing.

24. The portable light device of claim 23 wherein:
the articulating arm is rotatable about a first axis.

25. The portable light device of claim 24 further comprising:
a connector coupled to the articulating arm,
wherein:
at least a portion of the light source is inside the connector; and
the connector is rotatable about a second axis perpendicular to the first axis.

26. The portable light device of claim 25 wherein:
an on/off switch coupled to the light source.

27. The portable light device of claim 22 wherein:
the articulating arm is rotatable about a first axis.

28. The portable light device of claim 27 further comprising:
a connector coupled to the articulating arm,
wherein:
at least a portion of the light source is inside the connector; and
the connector is rotatable about a second axis perpendicular to the first axis.

29. The portable light device of claim 28 further comprising:
an on/off switch coupled to the light source.

30. The portable light device of claim 22 further comprising:
a connector coupled to the articulating arm,
wherein:
at least a portion of the light source is inside the connector; and
the connector is rotatable about an axis.

31. The portable light device of claim 30 further comprising:
an on/off switch coupled to the light source.

32. The portable light device of claim 22 further comprising:
an on/off switch coupled to the light source.

33. The portable light device of claim 22 wherein:
the clip is comprised of a polycarbonate material.

34. A portable light device comprising:
a USB connector;
an electrical cord coupled to the USB connector;
a retraction mechanism coupled to the electrical cord;
a light source coupled to the electrical cord;
an articulating arm coupled to the light source; and
a connector coupled to the articulating arm,
wherein:
the electrical cord electrically couples the light source to the USB connector;
the retraction mechanism is capable of retracting the electrical cord within the retraction mechanism;
the articulating arm is capable of movement between an open position and a closed position;
the articulating arm is rigid;
the connector is capable of movement into and out of a central position;
the articulating arm comprises a first detent resistive to movement of the articulating arm out of the closed position; and
the connector comprises a second detent resistive to movement of the connector away from the central position.

35. The portable light device of claim 34 wherein:
the retraction mechanism comprises:
a housing;
an actuator extending through a portion of the housing;
a spring inside the housing; and
a spool inside the housing; and
a manipulation of the actuator permits the spring to uncoil to rotate the spool to wind the electrical cord around the spool and to retract the electrical cord into the housing.

36. The portable light device of claim 35 further comprising:
a clip coupled to the retraction mechanism.

37. The portable light device of claim 36 wherein:
the USB connector is secured by the clip when the electrical cord is retracted within the retraction mechanism.

38. The portable light device of claim 36 wherein:
the articulating arm is rotatable about a first axis.

39. The portable light device of claim 38 wherein:
at least a portion of the light source is inside the connector; and
the connector is rotatable about a second axis perpendicular to the first axis.

40. The portable light device of claim 39 wherein:
the clip is comprised of a polycarbonate material.

41. The portable light device of claim 40 further comprising:
a light baffle circumscribing the light source.

42. The portable light device of claim 41 further comprising:
an on/off switch coupled to the light source.
